(19) United States
(12) Patent Application Publication
(10) Pub. No.: US 2025/0374866 A1
(43) Pub. Date: Dec. 11, 2025

(54) UNMANNED AERIAL VEHICLE AND CONTROL MODULE FOR VEGETATION TRIMMING

(71) Applicant: Xylem I LLC, Norfolk, VA (US)

(72) Inventor: Randolph D Hoover, Virginia Beach, VA (US)

(21) Appl. No.: 19/199,277

(22) Filed: May 5, 2025

Related U.S. Application Data
(60) Provisional application No. 63/642,000, filed on May 3, 2024.

(51) Int. Cl. A01G 3/08; B64U 50/33; B64U 101/40

(52) U.S. Cl. CPC A01G 3/088; B64U 50/33; B64U 2101/40

(57) ABSTRACT

An unmanned aerial vehicle having a petrochemical-based engine powering at least one rotational blade for achieving flight provides for improved vegetation removal. The AEV includes a power transformer connected to the engine, the transformer generating electrical power from the operation of the engine and a plurality of electrically-powered blade units, each unit having a blade powered by a motor. In the AEV, a plurality of electrical connectors provide for transferring the electrical power generated by the transformer to each of the electrical motors of the blade units for causing circular rotation of the corresponding blade such that unmanned aerial vehicle is operative to trim the vegetation using the plurality of blade units powered by the engine.

### RELATED APPLICATIONS

This application is a non-provisional application relating to and claiming priority to U.S. Patent Application Ser. No. 63/642,000 filed May 3, 2024.

### FIELD OF THE INVENTION

The invention relates generally to an unmanned aerial vehicle for vegetation trimming and control modules associated therewith.

### BACKGROUND

There are two current solutions for trimming vegetation, including trimming vegetation located in remote areas.

A first solution is manual trimming. Manual trimming includes workers manually hiking to remote locations, carrying heavy loads of equipment and then manually scaling trees to trim vegetation by hand. This approach is slow, time-consuming, and dangerous. Should any type of accident occur, the workers are a high risk of lose of life because of the remoteness of these operations and the difficulty of timely access to life saving treatments.

The second solution is using a helicopter having a trimming system of an appendage of buzzsaws hanging underneath. This solution allows for high speed trimming of vegetation using the helicopter but is fraught with its own degrees of complications. There is the risk of the helicopter crashing, with having buzzsaws and being in remote areas, there is a substantial risk of pilot death. The second complication, and much more prevalent, is jamming or other operational malfunctions of the blades. Upon any type of blade malfunction, the helicopter must abort the trimming operations, find a clearing to land, land, and then manually correct the blade jam. This is dangerous and highly inefficient.

An existing solution is noted in U.S. patent application Ser. No. 17/331,829 disclosed in Publication No. 2022/0377990, hereinafter referred to as Pub. '990. Pub. '990 notes an electric power source 120 powering the blades 124. This embodiment, while improving on using the helicopter itself as a power source for blade operations, still suffers from the operational problems associated with jams or malfunctions and requiring the helicopter to land and becoming non-operational. Additionally, the Pub. '990 power source 120 requires continuous charging independent of the helicopter, thus the power source available within the blade assembly limits operational time and efficacy.

The Pub. '990 system further uses the single motor source 120. With a single source, all blades 124 must therefore rotate in the same direction. By having all blades rotate in the same direction, any jamming caused by vegetation will require the helicopter to prematurely land and the manual removal of the jam. This adds additional operational risk, as well as further downtime and reducing the efficiency of the vegetation trimming operations.

There exists a need for a system for trimming vegetation overcoming the problems noted above.

### BRIEF DESCRIPTION

The present invention overcomes the prior art limitations by incorporating an assembly of multi-directional saws, each of the saws individually powered by separate electrical motor sources. The assembly includes attachments to unmanned aerial vehicle (AEV), also commonly referred to as a drone. The drone itself is powered either via battery or a combustion engine that generates an electrical output. The engine powers the flight of the drone, accounting for the carriage weight of the assembly. The drone power source can provide electrical sources to power the individual blades. For example, if the drone power source is a battery source, the battery can also power the blades. In another example, if the drone power source is a petrochemical engine, such as a diesel engine, the engine generates an electrical current via a transformer and the current is distributable to power the blades. As each blade is individually controlled, each blade to be powered in a forward spin or a reverse spin, independent of the other blades.

The present invention further includes control modules disposed on the AEV for sending operation data to a land-based operating module. The control modules measure operating conditions associated with the AEV, including operating conditions of the rotation of the blades, including detection of irregular operations such as a blade being jammed. Based on instructions from the operating module, the AEV may reverse polarity of a jammed or non-functioning blade to remove any debris obscuring normal operation(s).

Herein, the present invention overcomes safety concerns with human operators by building upon AEV technology for vegetation trimming. Moreover, the present invention overcomes safety and efficiency concerns associated with jammed blades by using separate electrical power sources for each of the individual blades.

### BRIEF DESCRIPTION OF THE DRAWINGS

The invention will be described with respect to the following drawing figures, in which like numerals represent like features throughout the description, and in which:

FIG. 1 is an illustration of the AEV having the vegetation trimmer attached thereto;

FIG. 2 is an enlarged view of one of the saw segments of the vegetation trimmer;

FIG. 3 is an enlarged view of an electric motor assembly disposed within the saw segment;

FIG. 4 is an illustration of a multiple interconnected saw segments of the vegetation trimmer; and

FIGS. 5A and 5B are illustrations of a control module and the disassembled AEV as part of the transportation and delivery system.

### DETAILED DESCRIPTION

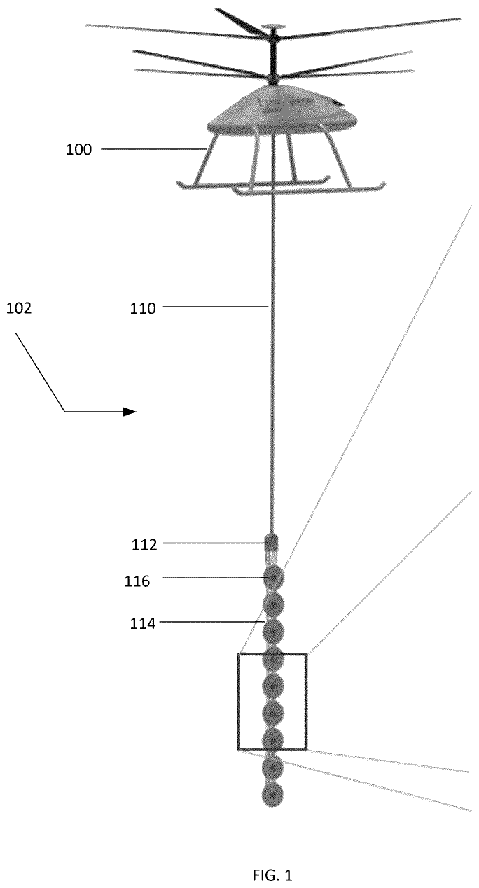

FIG. 1 is an illustration of an AEV 100 having a trimming assembly 102 attached thereto. The AEV 100 with trimming assembly 102 provides for improved vegetation removal services in remote areas including improving user safety by elimination of pilot risk, as well as operations of the trimming assembly 102 allowing for in-flight management of operation complications.

In one embodiment, the drone 100 may be an operational drone as commercially available from Freedom Lift Innovations having a payload capacity of carrying up to 3500 lbs. In one embodiment, the drone 100 is powered via an on-board petrochemical (diesel) engine capable of generating a secondary electrical output via a transformer.

In one embodiment, the drone includes a total electrical output of 300 kV including 100 kV constant for powering take off and up to 150 kV surge of power while in flight. The above voltages are merely one embodiment and not expressly limiting in nature, whereby further voltages may be utilized within the scope of this device.

In another embodiment, the drone 100 may use one or more battery sources capable of both providing prolonged flight, but also carrying and powering the trimming assembly 102.

The drone 100 includes operating controls responsive to user instructions for in-flight navigation. The drone 100 further includes operating controls relative to the trimming assembly 102. In a standard operation, the drone 100 includes a plurality of operational sensors monitoring operating (flight) conditions, as well as cameras providing visual feedback. Other types of sensors can include LIDAR, infra-red, global-positioning sensors, altimeter sensors, power meter(s), and other types of sensors as recognized by a skilled artisan.

The trimming assembly 102 includes an arm 110, connector 112, and a plurality of units 114, each having a blades 116 thereon. Varying embodiments can include any number of units 114, where FIG. 1 illustrates 9 units as exemplary in nature.

In one embodiment, the connector 112 is a structural element for securing the units 114 to the drone. In another embodiment, the connector 112 can include additional functional elements, including a release mechanism and other elements for providing further interactions between the drone 100 and the units 114.

The trimming assembly 102 includes electrical connectors from the drone 100 through the arm 110 and into each of the units 114. These electrical connections allow for individual powering of each of the blades 116 for each unit 114. As described in greater detail below, the blades can be wired in series for all blades operating in the same direction and at the same RPM, where in other embodiments the blades can be wired in a parallel so that the RPM and rotational direction of each blade can be individually managed.

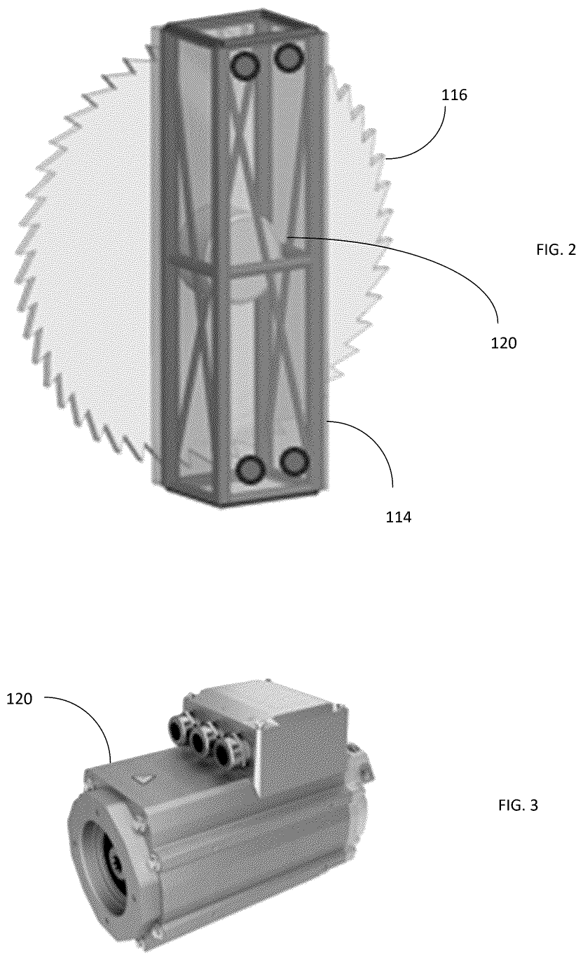

FIG. 2 illustrates an exploded view of one of the blade units 114 having the blade 116 connected thereto. Further partial visible, the unit 114 includes a motor 120 disposed internally within a protective cover.

In one embodiment, the protective cover can be made of any suitable material, including but not limited to aluminum, steel, reenforced steel.

As illustrated in FIG. 1, during normal operation, a number of consecutively sequenced units 114 are connected forming the line of blades for aerial trimming. In one embodiment, each of the units 114 are wired in series. In another embodiment, the units 114 can be wired in parallel. In one embodiment, the units include quick disconnect plugs or other mechanisms for disengagement with other units 114. The plugs can include electrical connectors for distributing electricity to the motor turning the blade.

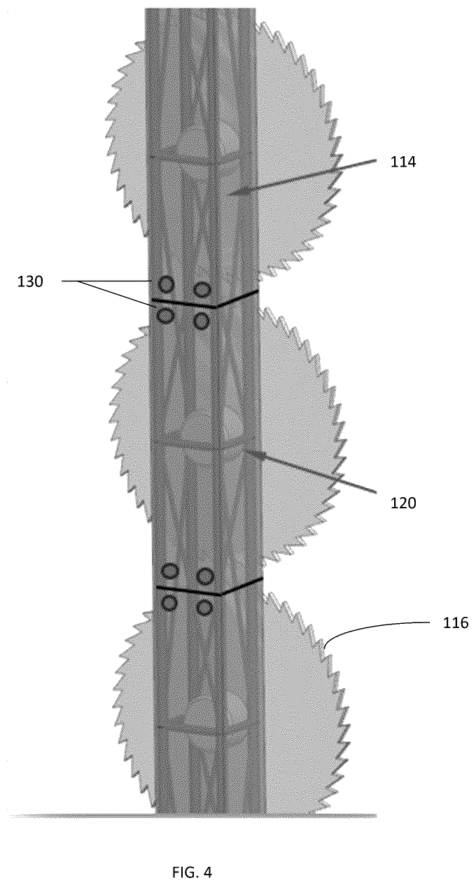

The motor 120 is further illustrated in FIG. 3. In one embodiment, the motor 120 is a magnetic motor operated by electric inputs. Where the motor 120 is electrically controlled, the rotational direction and speed of the motor and the connected blade (116 of FIG. 2) is adjustable.

Where FIG. 2 illustrates a single element 114 and FIG. 3 illustrates a single motor 120 within the element 114, FIG. 4 illustrates an implementation of the vegetation trimming device. Where trimming includes overgrown vegetation having substantial height, a preferred embodiment uses a multiple number of connected individual elements 114.

All motors are wired in series, thereby providing synchronized rpms. Moreover, the blades are reversible such that be reversing the polarity of the power, the rotational direction of the blades can be reversed. Where one or more blades are jammed, reversing the rotational direction of the blade can readily clear the obstructions.

In another embodiment, the motors are wired in parallel allowing for blade-specific rotation direction and rpms. Parallel wiring can include extra wiring connectors or gates for distributing electricity across prior blade units to powered units and maintaining the parallel operations. For example, a blade unit may include dual connectors, the first connector bypassing electricity through the unit and the second connector directing electricity to power the unit itself.

In one embodiment, the blades can rotate up to an rpm of 6500. Moreover, based on the controls for the motor, the saw blade speed is variable and thus can be adjusted as appropriate for different working conditions. In one embodiment, the blade has a diameter of 24 inches and the entire saw assembly can weigh between 500 to 1500 lbs., well within the 3500 lb. carrying capacity of the drone. It is recognized these values are representational in nature and not expressly limiting, whereby smaller blades and lighter assemblies can be utilized with drones having lower carrying capacities, as well as larger blades and heavier assemblies for drones with greater carrying capacities.

FIG. 4 shows the sample embodiment of three connected elements 114, having motors 120 powering the blades 116. Moreover, this embodiment includes clipping elements 130 for securing the elements 114 together. This clipping elements130 provide for quick assembly as well as disassembly for non-use or for replacing a broken or malfunctioning element 114.

It is recognized by a skilled artisan that varying embodiments may utilize any suitable number of connected elements and the disclosure is not expressly limited to any specific number. The number of connected elements 114 can be based on numerous operations factors, including safety issues, weight issues associated with payload capacity of the AEV, available elements, type of vegetation trimming operations, etc.

In one embodiment, both the wiring and support poles are capable of being quickly connected for quick assembly. Similarly, the elements can be disengaged, for example of a middle element is broken or otherwise malfunctions, that element can be disconnected, and a replacement element slotted therein. This allows for quick replacement of any damaged sections.

In further embodiments, the AEV and blade units includes a plurality of sensors monitoring flight and trimming operations. One embodiment of sensors can include cameras provide image capture of the AEV as well as the blade units. Cameras can be mounted on the AEV itself, on the blade units, on a connector connecting the units to the AEV, for example.

Another example of sensors can include LIDAR sensor(s) used for measuring depth/distance for vegetation trimming. Positional sensors may be used, for example GPS sensor(s), altimeters, among others. Another type of sensor may be a power sensor measuring the rotational speed/power of the rotation of the blade(s).

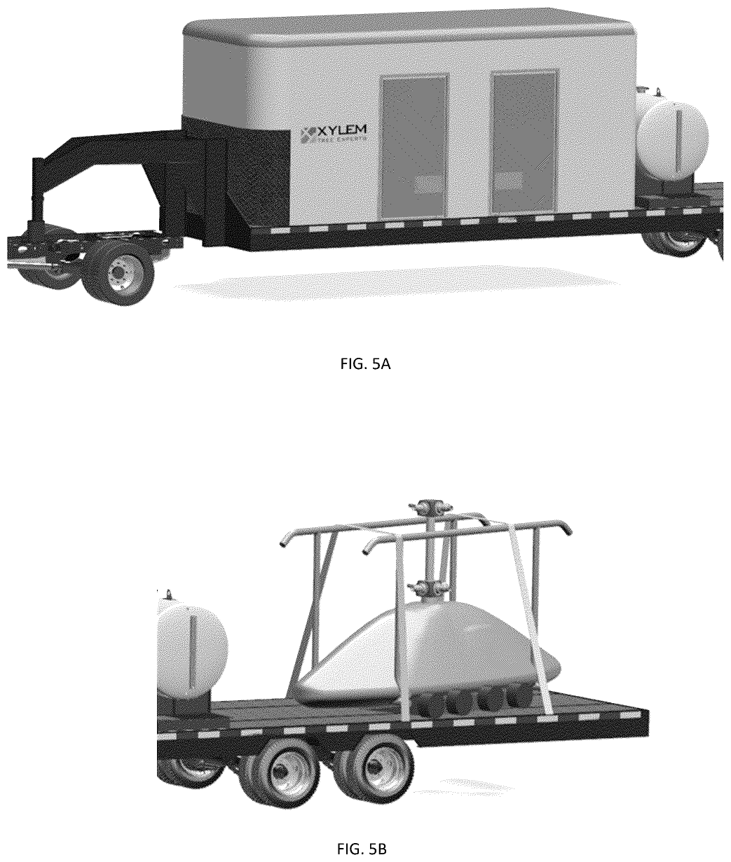

In providing vegetation trimming operations, one embodiment may include a mobile transport and command center. FIGS. 5A and 5B illustrate one exemplary embodiment of a trailer having a control unit on a front end and a disassembly AEV on a back end.

Assembling the drone includes attaching blades, as well as additional power sourcing, such as a battery charging and installing fuel on the device.

The AEV communicates with the control center and can be manually operated by a user. The user can view flight sensor data recorded by AEV as well as visual feedback from on-board cameras. The user operates the AEV to fly to the vegetation, enables the saws and begins trimming vegetation.

If a sensor or visual feedback indicates one or more blades have been jammed, where the prior art required withdrawal from trimming operations, the operator can then manually instruct the jammed unit to reverse the polarity of the blade. If additional efforts are required, neighboring units can also be reversed. This then allows for jam removal mid-flight, never having to land and never endangering the human operator.

FIGS. attached hereto are conceptual illustrations allowing for an explanation of the present invention. Notably, the figures and examples above are not meant to limit the scope of the present invention to a single embodiment, as other embodiments are possible by way of interchange of some or all of the described or illustrated elements. Moreover, where certain elements of the present invention can be partially or fully implemented using known components, only those portions of such known components that are necessary for an understanding of the present invention are described, and detailed descriptions of other portions of such known components are omitted so as not to obscure the invention. In the present specification, an embodiment showing a singular component should not necessarily be limited to other embodiments including a plurality of the same component, and vice-versa, unless explicitly stated otherwise herein. Moreover, Applicant does not intend for any term in the specification or claims to be ascribed an uncommon or special meaning unless explicitly set forth as such. Further, the present invention encompasses present and future known equivalents to the known components referred to herein by way of illustration.

The foregoing description of the specific embodiments so fully reveals the general nature of the invention that others can, by applying knowledge within the skill of the relevant art(s) (including the contents of the documents cited and incorporated by reference herein), readily modify and/or adapt for various applications such specific embodiments, without undue experimentation, without departing from the general concept of the present invention. Such adaptations and modifications are therefore intended to be within the meaning and range of equivalents of the disclosed embodiments, based on the teaching and guidance presented herein.

What is claimed is:

1. An aerial vegetation trimming system comprising:
an unmanned aerial vehicle having a petrochemical-based engine powering at least one rotational blade for achieving flight;
a power transformer connected to the engine, the transformer generating electrical power from the operation of the engine;
a plurality of electrically-powered blade units, each unit having a blade powered by a motor; and
a plurality of electrical connectors for transferring the electrical power generated by the transformer to each of the electrical motors of the blade units for causing circular rotation of the corresponding blade such that unmanned aerial vehicle is operative to trim the vegetation using the plurality of blade units powered by the engine.

2. The system of claim 1, wherein the engine is a diesel engine.

3. The system of claim 1, wherein the plurality of blade units are wired in parallel.

4. The system of claim 3, wherein each of the plurality of blades can rotate their corresponding blade in a clockwise rotation or a counter-clockwise rotation independent of a blade rotation direction of the other plurality of blades.

5. The system of claim 4 further comprising a jam sensor detecting a jam in one of the plurality of blades and a blade rotation control device for changing the blade rotation direction to clear the jam.

6. The system of claim 1 wherein the motor in each of the plurality of blade units is a magnetic motor.

7. The system of claim 1 wherein each of the plurality of blade units include a plurality of clipping elements such that blade units are connected in a vertical column by connection of the clipping elements.

8. The system of claim 1 further comprising:
a plurality of operational sensors disposed around the unmanned aerial vehicle and the blade units;
a control module receiving sensor data from the plurality of operational sensors; and
a transmission device transmitting the sensor data to a remote control station.

9. An aerial vegetation trimming system comprising:
an unmanned aerial vehicle having a battery-based engine powering at least one rotational blade for achieving flight;
a power distributer connected to the engine;
a plurality of electrically-powered blade units, each unit having a blade powered by a motor and receiving power from the battery-based engine as distributed through the power distributer; and
a plurality of electrical connectors for transferring the electrical power from the power distributer to each of the electrical motors of the blade units for causing circular rotation of the corresponding blade such that unmanned aerial vehicle is operative to trim the vegetation using the plurality of blade units powered by the engine.

10. The system of claim 1, wherein the plurality of blade units are wired in parallel.

11. The system of claim 10, wherein each of the plurality of blades can rotate their corresponding blade in a clockwise rotation or a counter-clockwise rotation independent of a blade rotation direction of the other plurality of blades.

12. The system of claim 11 further comprising a jam sensor detecting a jam in one of the plurality of blades and a blade rotation control device for changing the blade rotation direction to clear the jam.

13. The system of claim 9 wherein the motor in each of the plurality of blade units is a magnetic motor.

14. The system of claim 9 wherein each of the plurality of blade units include a plurality of clipping elements such that blade units are connected in a vertical column by connection of the clipping elements.

15. The system of claim 9 further comprising:
a plurality of operational sensors disposed around the unmanned aerial vehicle and the blade units;
a control module receiving sensor data from the plurality of operational sensors; and
a transmission device transmitting the sensor data to a remote control station.

16. An aerial vegetation trimming system comprising:
an unmanned aerial vehicle having an engine powering at least one rotational blade for achieving flight;
a plurality of electrically-powered blade units, each unit having a blade powered by a motor and receiving power from the engine;
a plurality of electrical connectors for transferring the electrical power from the power distributer to each of the electrical motors of the blade units for causing circular rotation of the corresponding blade;
a plurality of operational sensors disposed around the unmanned aerial vehicle and the blade units;
a control module receiving sensor data from the plurality of operational sensors; and
a transmission device transmitting the sensor data to a remote control station;
wherein that unmanned aerial vehicle is operative to trim the vegetation using the plurality of blade units powered by the engine and operating in response to feedback from the operational sensors.

17. The system of claim 16, wherein the plurality of blade units are wired in parallel.

18. The system of claim 17, wherein each of the plurality of blades can rotate their corresponding blade in a clockwise rotation or a counter-clockwise rotation independent of a blade rotation direction of the other plurality of blades.

19. The system of claim 16 further comprising a jam sensor detecting a jam in one of the plurality of blades and a blade rotation control device for changing the blade rotation direction to clear the jam.

20. The system of claim 16 wherein each of the plurality of blade units include a plurality of clipping elements such that blade units are connected in a vertical column by connection of the clipping elements.
